(19) United States
(12) Patent Application Publication
(10) Pub. No.: US 2017/0266648 A1
(43) Pub. Date: Sep. 21, 2017

(54) IRON AND COBALT CATALYZED HYDROGEN ISOTOPE LABELING OF ORGANIC COMPOUNDS

(71) Applicant: THE TRUSTEES OF PRINCETON UNIVERSITY, Princeton, NJ (US)

(72) Inventors: Paul CHIRIK, Princeton, NJ (US); Renyuan YU, Beijing (CN)

(21) Appl. No.: 15/329,919

(22) PCT Filed: Jul. 29, 2015
(86) PCT No.: PCT/US15/42691

§ 371 Date: Jan. 27, 2017

Related U.S. Application Data
(60) Provisional application No. 62/030,401, filed on Jul. 29, 2014.

(51) Int. Cl. B01J 31/22; C07F 15/02; C07B 59/00; B01J 31/18

(52) U.S. Cl. CPC B01J 31/2295; B01J 31/1805; B01J 31/181; C07F 15/02; C07B 59/004; B01J 2531/842; B01J 2531/845; B01J 2231/46; C07B 2200/05

(57) ABSTRACT

Methods of isotopic labeling are described herein. For example, a method of isotopically labeling an organic compound, in some embodiments, comprises providing a reaction mixture including the organic compound, an iron complex or a cobalt complex and a source of deuterium or tritium. The organic compound is labeled with deuterium or tritium in the presence of the iron complex or cobalt complex or derivative of the iron complex or cobalt complex.

### RELATED APPLICATION DATA

The present application claims priority pursuant to 35 U.S.C. §119(e) to U.S. Provisional Patent Application Ser. No. 62/030,401 filed Jul. 29, 2014 which is incorporated herein by reference in its entirety.

### STATEMENT OF GOVERNMENT RIGHTS

This invention was made with government support under Grant No. CHE-1026084 awarded by the National Science Foundation. The government has certain rights in the invention.

### FIELD

The present invention relates to isotopically labeling organic compounds and, in particular, to labeling organic compounds with deuterium or tritium with iron group catalysts.

### BACKGROUND

Isotopic labeling of pharmaceutical compounds is often employed to evaluate such compounds through one or more metabolic pathways. Traditionally, labeling of organic compounds required the use of high temperatures and pressures along with expensive catalytic species. For example, iridium, platinum and palladium-based catalysts are widely used for tritium labeling of organic compounds. The high cost and potential toxicity of these catalysts coupled with high tritium pressures are less than desirable, thereby calling for alternative catalytic species and pathways for isotopic labeling. Deuterated organic compounds also find value as drug candidates and probes of various metabolic pathways.

### SUMMARY

In view of the foregoing disadvantages, isotopic labeling methods employing iron group catalytic species are described herein. For example, a method of isotopically labeling an organic compound, in some embodiments, comprises providing a reaction mixture including the organic compound, an iron complex or a cobalt complex and a source of deuterium or tritium. The organic compound is labeled with deuterium or tritium in the presence of the iron complex or cobalt complex or derivative of the iron complex or cobalt complex. In some embodiments, the iron complex or cobalt complex comprises N-heterocylic carbene ligands. Further, the deuterium or tritium labeling can be specific to an aryl or heteroaryl moiety of the organic compound. Alternatively, labeling can be specific to aliphatic carbon atom(s) alpha to an NH functionality of the organic compound.

In another aspect, methods of conducting isotopic labeling studies are described herein. In some embodiments, a method comprises providing a reaction mixture comprising a pharmaceutical compound, an iron complex or cobalt complex and a source of tritium. The pharmaceutical compound is labeled with tritium in the presence of the iron complex or cobalt complex or derivative of the iron complex or cobalt complex and subsequently recovered from the mixture. The tritium labeled pharmaceutical compound is administered in vitro or in vivo.

In some specific embodiments, catalytic species for methods of isotopic labeling described herein are of formula (I):

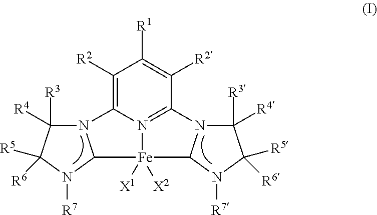

wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹ and X² are independently selected from the group consisting of hydrogen, alkyl, aryl, heteroalkyl, heteroaryl, H₂, N₂ and halo.

In another aspect, catalytic species for isotopic labeling processes described herein are of formula (II):

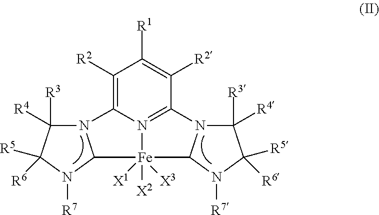

wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀-alkyl and (C₁-C₁₀)-alkenyl and wherein X¹-X³ are independently selected from the group consisting of hydrogen, alkyl, aryl, heteroalkyl, heteroaryl, H₂, N₂ and halo.

These and other embodiments are further described in the following detailed description.

### BRIEF DESCRIPTION OF THE DRAWINGS

FIG. 1 illustrates various iron complexes for use in isotopic labeling methods according to some embodiments described herein.

FIG. 2 illustrates various iron complexes for use in isotopic labeling methods according to some embodiments described herein.

FIG. 3 illustrates various iron complexes for use in isotopic labeling methods according to some embodiments described herein.

FIG. 4 illustrates various iron complexes for use in isotopic labeling methods according to some embodiments described herein.

FIG. 5 illustrates various cobalt complexes for use in isotopic labeling methods according to some embodiments described herein.

FIG. 6 illustrates a labeling scheme including iron catalyst and deuterated product according to one embodiment of a method described herein.

FIG. 7 illustrates a labeling scheme including iron catalyst and deuterated product according to one embodiment of a method described herein.

FIG. 8 illustrates a labeling scheme including iron catalyst and deuterated product according to one embodiment of a method described herein.

FIG. 9 illustrates various pharmaceutical compositions tritiated according to methods described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### Definitions

The term “alkyl” as used herein, alone or in combination, refers to a straight or branched saturated hydrocarbon group optionally substituted with one or more substituents. For example, an alkyl can be C₁-C₃₀.

The term “alkenyl” as used herein, alone or in combination, refers to a straight or branched chain hydrocarbon group having at least one carbon-carbon double bond and optionally substituted with one or more substituents

The term “aryl” as used herein, alone or in combination, refers to an aromatic monocyclic or multicyclic ring system optionally substituted with one or more ring substituents.

The term “heteroaryl” as used herein, alone or in combination, refers to an aromatic monocyclic or multicyclic ring system in which one or more of the ring atoms is an element other than carbon, such as nitrogen, oxygen and/or sulfur.

The term “cycloalkyl” as used herein, alone or in combination, refers to a non-aromatic, mono- or multicyclic ring system optionally substituted with one or more ring substituents.

The term “heterocycloalkyl” as used herein, alone or in combination, refers to a non-aromatic, mono- or multicyclic ring system in which one or more of the atoms in the ring system is an element other than carbon, such as nitrogen, oxygen or sulfur, alone or in combination, and wherein the ring system is optionally substituted with one or more ring substituents.

The term “heteroalkyl” as used herein, alone or in combination, refers to an alkyl moiety as defined above, having one or more carbon atoms in the chain, for example one, two or three carbon atoms, replaced with one or more heteroatoms, which may be the same or different, where the point of attachment to the remainder of the molecule is through a carbon atom of the heteroalkyl radical.

The term “alkoxy” as used herein, alone or in combination, refers to the moiety RO—, where R is alkyl or alkenyl defined above.

The term “halo” as used herein, alone or in combination, refers to elements of Group VIIA of the Periodic Table (halogens). Depending on chemical environment, halo can be in a neutral or anionic state.

### I. Methods of Isotopic Labeling and Associated Catalytic Complexes

As described herein, a method of isotopically labeling an organic compound, in some embodiments, comprises providing a reaction mixture including the organic compound, an iron complex or a cobalt complex and a source of deuterium or tritium. The organic compound is labeled with deuterium or tritium in the presence of the iron complex or cobalt complex or derivative of the iron complex or cobalt complex.

Turning now to specific components, the reaction mixture includes an iron complex or cobalt complex. Any iron complex or cobalt complex operable to catalytically participate in labeling of the organic compound with deuterium or tritium can be employed. In some embodiments, the iron complex or cobalt complex comprises N-heterocylic carbene ligands. In such embodiments, the N-heterocylic carbene ligands can form a tridentate ligand in combination with an aryl or heteroaryl moiety. Suitable heteroaryl moiety can be pyridine, thereby forming a pyridine di(N-heterocylic carbene) tridentate ligand shown in the chemical structures herein. For example, an iron complex of the reaction mixture can be of formula (I):

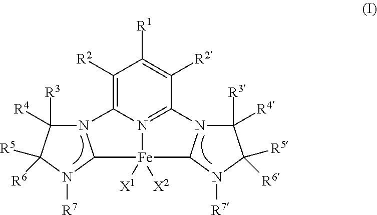

wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀-alkenyl and wherein X¹ and X² are independently selected from the group consisting of hydrogen, alkyl, aryl, heteroalkyl, heteroaryl, H₂, N₂ and halo.

In other embodiments, an iron complex of the reaction mixture can be of formula (II):

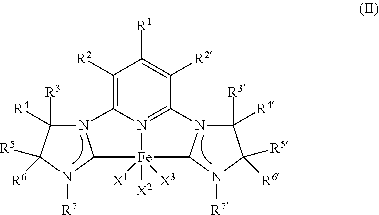

wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹-X³ are independently selected from the group consisting of hydrogen, alkyl, aryl, heteroalkyl, heteroaryl, H₂, N₂ and halo.

In further embodiments, an iron complex of the reaction mixture can be of formula (III):

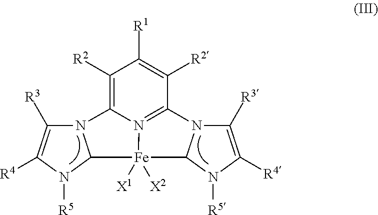

wherein R¹-R⁵ and R^{2′}-R^{5′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹ and X² are independently selected from the group consisting of hydrogen, alkyl, aryl, heteroalkyl, heteroaryl, H₂, N₂ and halo.

An iron complex of the reaction mixture can also be of formula (IV):

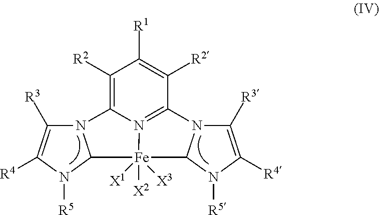

wherein R¹-R⁵ and R^{2′}-R^{5′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹ and X² are independently selected from the group consisting of hydrogen, alkyl, aryl, heteroalkyl, heteroaryl, H₂, N₂ and halo.

An iron complex of the reaction mixture, in some embodiments, is of formula (V):

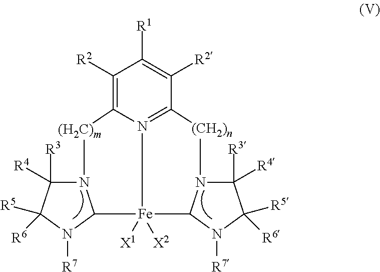

wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀-alkenyl and wherein X¹-X³ are independently selected from the group consisting of hydrogen, alkyl, aryl, heteroalkyl, heteroaryl, H₂, N₂ and halo and wherein m and n are integers independently selected from 1 to 5.

Additionally, an iron complex of the reaction mixture can be of formula (VI):

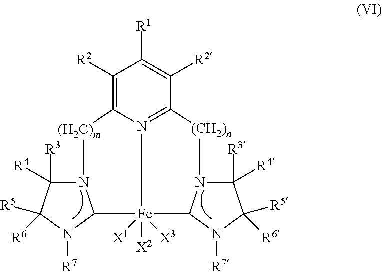

wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹-X³ are independently selected from the group consisting of hydrogen, alkyl, aryl, heteroalkyl, heteroaryl, H₂, N₂ and halo and wherein m and n are integers independently selected from 1 to 5.

An iron complex of the reaction mixture, in some embodiments, is of formula (VII):

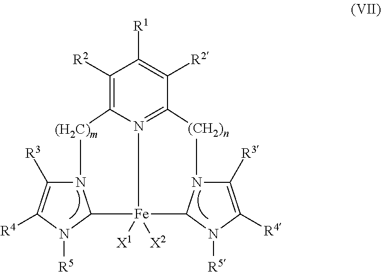

wherein R¹-R⁵ and R^{2′}-R^{5′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹ and X² are independently selected from the group consisting of hydrogen, alkyl, aryl, heteroalkyl, heteroaryl, H₂, N₂ and halo and wherein m and n are integers independently selected from 1 to 5.

In some embodiments, an iron complex of the reaction mixture is of formula (VIII):

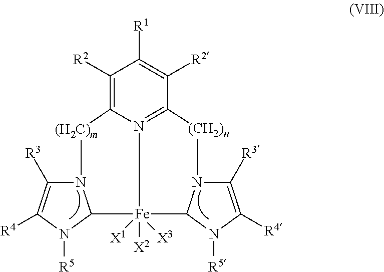

wherein R¹-R⁵ and R^{2′}-R^{5′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹-X³ are independently selected from the group consisting of hydrogen, alkyl, aryl, heteroalkyl, heteroaryl, H₂, N₂ and halo and wherein m and n are integers independently selected from 1 to 5.

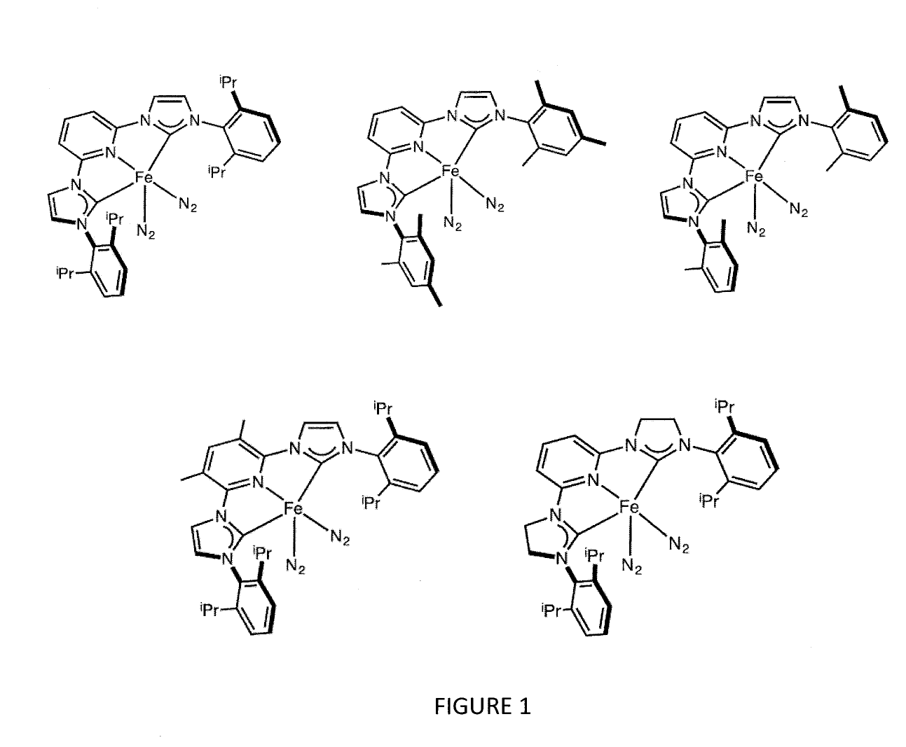

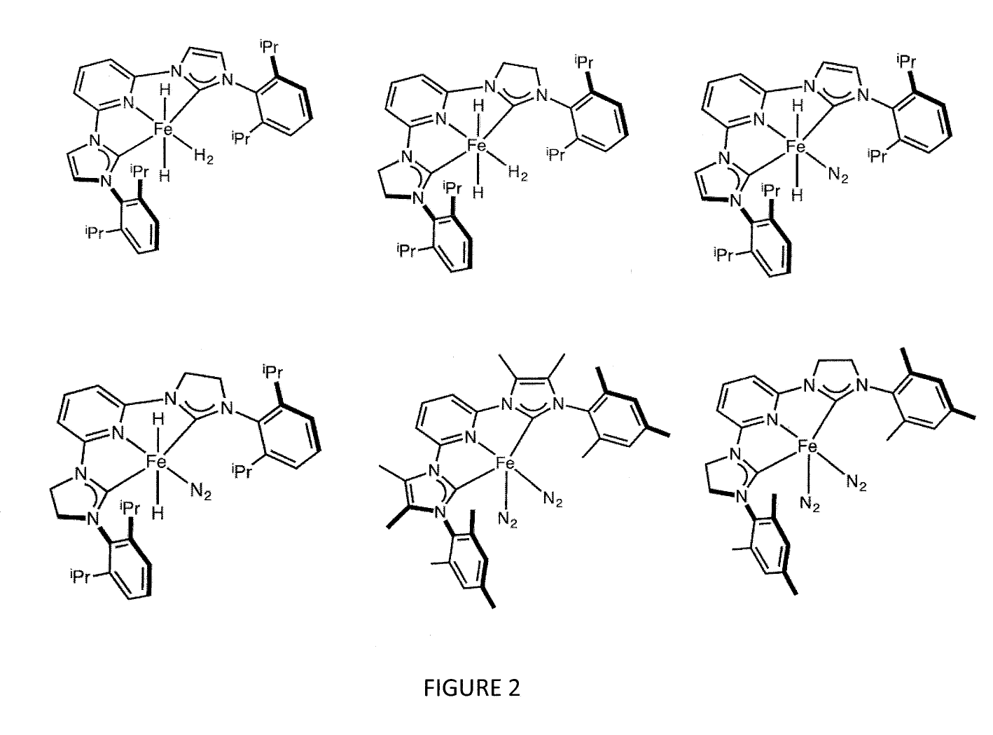

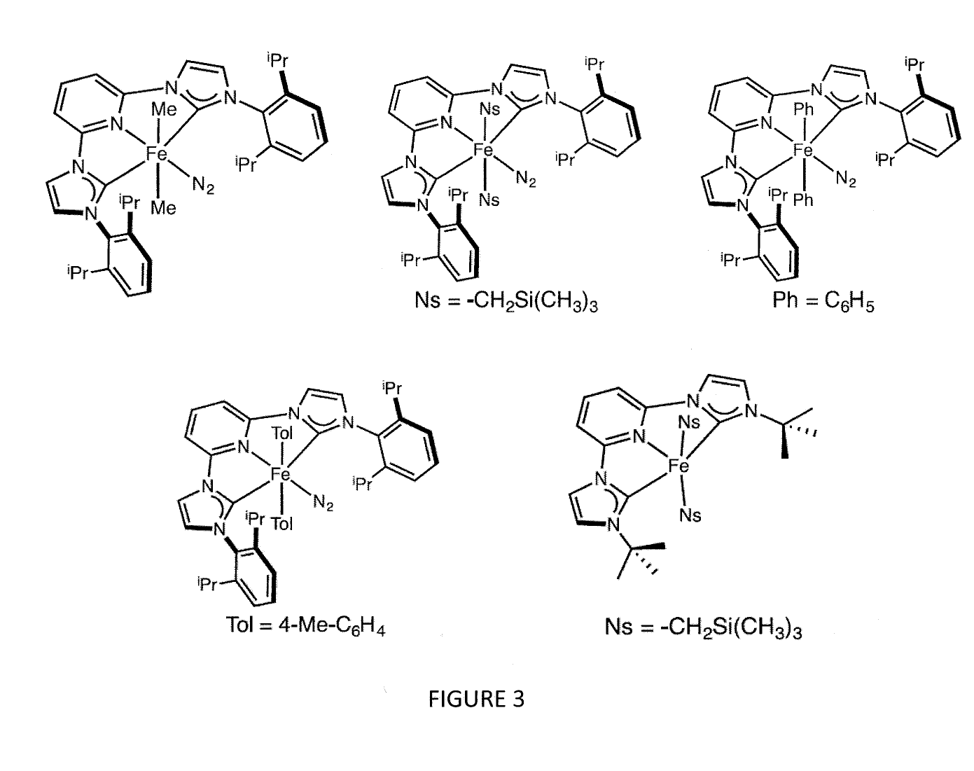

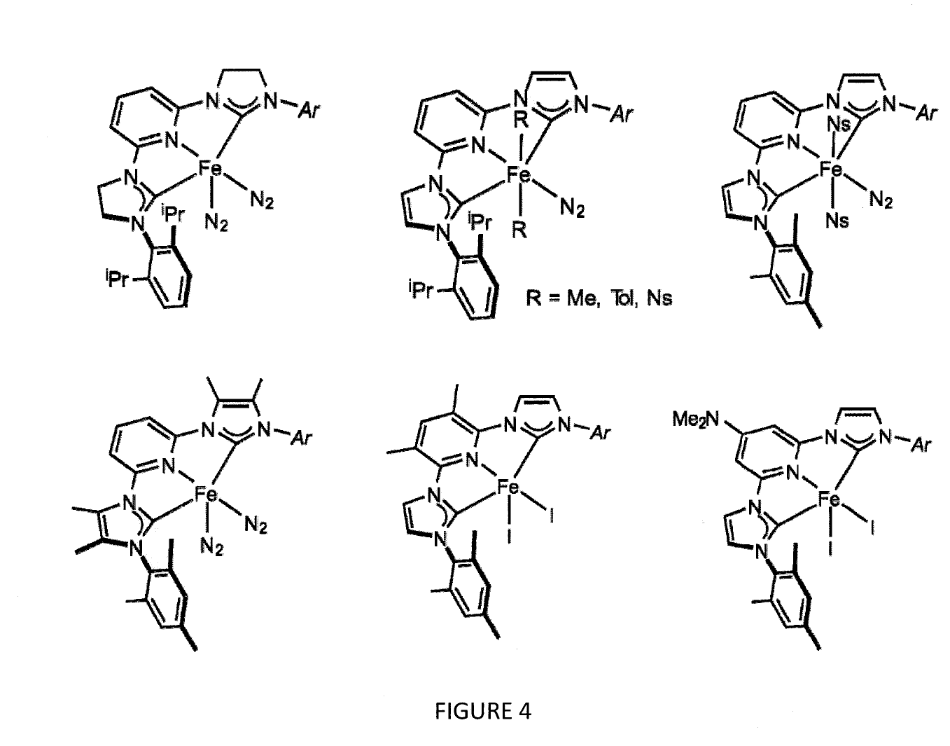

In several specific embodiments of formulas (I), (II), (V) and (VI), R⁷ and R^{7′} can be aryl-alkyl, such as 2,6-diisopropyl-phenyl. Similarly, in several specific embodiments of formulas (III), (IV), (VII) and (VIII), R⁵ and R^{5′} can be aryl-alkyl, such as 2,6-diisopropyl-phenyl. Moreover, in such embodiments, X¹ and X² of Formulas (I), (III), (V) and (VII) and X¹-X³ of Formulas (II), (IV), (VI) and (VIII) can be independently selected from the group consisting of hydrogen, H₂, N₂, alkyl, aryl, heteroalkyl and heteroaryl. In some embodiments, heteroalkyl is of formula

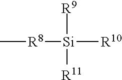

wherein R⁸ is selected from the group consisting of alkyl, alkenyl, aryl, heteroaryl, alkyl-aryl, alkyl-heteroaryl, aryl-alkyl and heteroaryl-alkyl and R⁹-R¹¹ are independently selected from the group consisting of hydrogen, alkyl, alkenyl, aryl, alkyl-aryl, alkoxy and hydroxy. FIGS. 1-4 illustrate non-limiting examples of iron complexes for use in isotopic labeling methods described herein.

Alternatively, cobalt complexes can be employed in the reaction mixture as suitable catalyst for labeling of organic compounds with deuterium or tritium. For example, a cobalt catalyst of formula (IX) can be added to the reaction mixture:

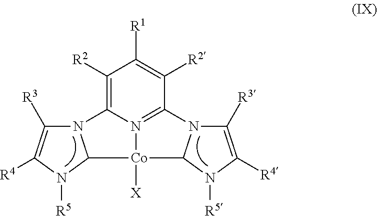

wherein R¹-R⁵ and R^{2′}-R^{5′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀-alkyl and (C₁-C₁₀)-alkenyl; and wherein X is selected from the group consisting of hydrogen, alkyl, aryl, heteroalkyl, heteroaryl, H₂, N₂ and halo.

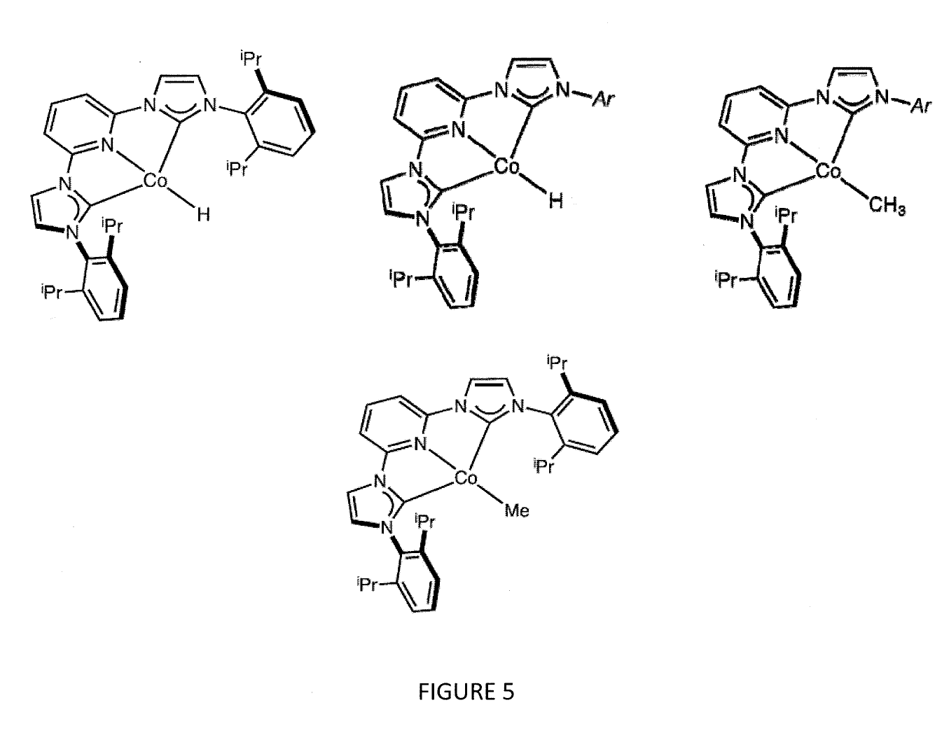

In other embodiments, a cobalt complex of formula (X) can be added to the reaction mixture:

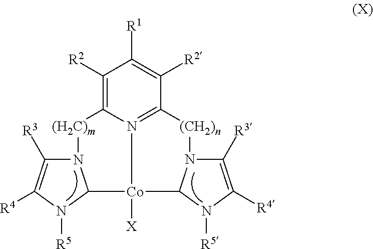

wherein R¹-R⁵ and R^{5′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl; and wherein X is selected from the group consisting of hydrogen, alkyl, aryl, heteroalkyl, heteroaryl, H₂, N₂ and halo and wherein m and n are integers independently selected from 1 to 5. FIG. 5 illustrates non-limiting examples of iron complexes for use in methods described herein.

In further aspects, iron or cobalt complexes of formula (XI) can be present in the reaction mixture for catalytic isotopic labeling of organic compounds:

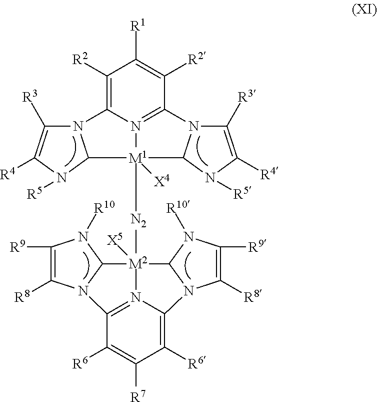

wherein R¹-R¹⁰, R^{2′}-R^{6′} and R^{8′}-R^{10′} are independently selected from the group consisting hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein M is selected from the group consisting of iron and cobalt and wherein X⁴ and X⁵ are optionally present and independently selected from the group consisting of hydrogen, alkyl, aryl, heteroalkyl, heteroaryl, H₂, N₂ and halo.

As described herein, labeling of organic compounds with deuterium or tritium catalytically proceeds in the presence of the iron complex or cobalt complex. Therefore, the iron or cobalt complex may participate in mechanistic pathway(s) leading to organic compound labeling. Such participation can result in the labeling reaction occurring in the presence of one or more derivatives of the iron complex or cobalt complex. For example, the labeling reaction may occur in the presence of an iron complex derived from formulas (I)-(VIII) herein. Similarly, the labeling reaction may occur in the presence of a cobalt complex derived from formulas (IX) or (X) herein.

The iron complex or cobalt complex can be present in the reaction mixture in any amount not inconsistent with the deuterium and/or tritium labeling objectives described herein. In some embodiments, for example, the iron complex or cobalt complex is present in the reaction mixture in an amount of 0.001 to 0.1 equivalent of the amount of organic compound substrate.

Further, additive(s) or activator(s) can be added to the reaction mixture for use with the iron catalyst or cobalt catalyst in isotopic labeling of organic compounds. For example, in embodiments of iron and cobalt complexes of formulas (I)-(X) above where an X ligand is halo, activators can be added to the reaction mixture for the labeling process. Such activators include, but are not limited to, sodium, potassium, organolithium reagents, Grignard reagents, sodium hydride, sodium triethylborohydride and lithium aluminum hydride.

Organic compounds suitable for labeling according to methods described herein include aromatic hydrocarbon and/or aromatic heterocycle moieties. For example, organic compound of the reaction mixture can comprise phenyl, pyridyl, furanyl, thienyl or imidazole moieties or various combinations thereof. In such embodiments, labeling of the organic compound can occur at one or more sites on the aromatic ring structure(s). Moreover, organic compound of the reaction mixture can include one or more amine functionalities. In such embodiments, deuterium or tritium labeling can occur at one or more aliphatic carbons alpha to the amine functionality. As illustrated in the examples below, tritium labeling can occur at the alpha carbons of a secondary amine.

Various sources of deuterium and tritium can be employed in methods described herein. In some embodiments, deuterium gas or tritium gas is provided to the reaction mixture. A particular advantage of the present catalytic methods is ability to use reduced pressures of D₂ and T₂ gas for isotopic labeling. In several embodiments, D₂ or T₂ can be supplied to the reaction mixture at sub-atmospheric pressures for efficient labeling of the organic compounds. Table I provides various pressures at which D₂ or T₂ can be supplied to the reaction mixture.

TABLE I
D₂/T₂ Pressure (atm)

| D₂ Pressure | T₂ Pressure |
|---|---|
| 0.2-4 | 0.01-0.5 |
| 0.3-1 | 0.05-0.3 |
| 0.3-0.9 | 0.1-0.2 |

Deuterium sources other than D₂ are also available for use in labeling methods described herein. In some embodiments, deuterated organic solvent, such as C₆D₆, is added to the reaction mixture as the deuterium source. Similarly, additional tritium sources are available.

Iron or cobalt complex of the reaction mixture can be sensitive to moisture requiring use of moisture-free and/or inert conditions. Moreover, yield of labeled organic compound can be greater than 98%. In some embodiments, for example, yield of deuterated organic compound can generally range from 10% to greater than 98%. Additionally, yield of tritiated compound can generally range from 10-50%.

In some embodiments, the organic compound can serve as solvent for the reaction mixture. For example, various arene substrates can serve as reaction mixture solvent. Alternatively, solvent of the reaction mixture can be selected from cyclohexane, cyclopentane and ethereal solvents such as diethyl ether and tetrahydrofuran (THF). Polar aprotic solvents may also be used including dimethylformamide (DMF), dimethylacetamide (DMA) and N-methylpyrrolidone (NMP).

Further, isotopic labeling according to methods described herein can be administered at room temperature. Alternatively, the reaction mixture can be heated. In some embodiments, for example, the reaction mixture is heated to a temperature of 30-50° C.

### II. Methods of Conducting Isotopic Labeling Studies

In another aspect, methods of conducting isotopic labeling studies are described herein. In some embodiments, a method comprises provided a reaction mixture comprising a pharmaceutical compound, an iron complex or a cobalt complex and a source of tritium. The pharmaceutical compound is labeled with tritium in the presence of the iron complex or cobalt complex or derivative of the iron complex or cobalt complex and subsequently recovered from the mixture. The tritium labeled pharmaceutical compound is administered in vitro or in vivo.

Labeling of the pharmaceutical compound can generally proceed as described in Section I above. For example, iron complex or cobalt complex of the reaction mixture, in some embodiments, is selected from formulas (I)-(XI) described in Section I. Moreover, the tritium source can be T₂ gas supplied at pressures provided in Table I herein. Pharmaceutical compositions suitable for labeling according to methods described herein contain aromatic, heteroaromatic and/or amine functionalities.

Once the tritiated pharmaceutical composition is recovered, it can be administered to a biological environment in vitro or administered to a human or animal subject in vivo. Due to the radioactive properties of tritium, the labeled pharmaceutical compound can be studied at one or more points along a metabolic pathway. In some embodiments, the tritiated pharmaceutical composition or derivative thereof is recovered at the conclusion of metabolic processing.

These and other embodiments are further illustrated by the following non-limiting examples.

### Example 1—Catalytic Deuteration of Benzene Using Iron Catalyst

To a thick walled vessel was charged iron complex (0.03 mmol) and benzene (8 mmol). The iron complex employed was bis(imidazole-2-ylidene)pyridine iron bis(dinitrogen). Deuterium gas (1 atm) was administered into the vessel at −196° C. The process was carried out under inert and moisture free conditions. The resultant reaction mixture was allowed to warm to room temperature and stirred for 96 hours. After stirring, the vessel was opened and the labeled benzene was isolated via vacuum transfer from the reaction mixture and the extent of deuterium incorporation subsequently evaluated by NMR spectroscopy.

A general procedure of the analytical method used to characterize the reaction product was provided. To an NMR tube was transferred via syringe 15-20 mg of the reaction product, and 700-800 mg of a 75 nM ferrocene solution in DMSO-D₆. The extent of labeling was determined by comparing the integration (¹H NMR) of the signals versus ferrocene as the internal standard. ²H and ¹³C NMR spectra of the product sample were also collected as supplemental proof.

### Example 2—Deuteration of Naphthalene Using Iron Catalyst at Elevated Temperature

To a thick walled vessel was charged with iron complex of Example 1 (0.03 mmol), naphthalene (3 mmol) and tetrahydrofuran (9 mmol). Deuterium gas (1 atm) was administered into the vessel at −196° C. The process was carried out under inert and moisture free conditions. The resultant reaction mixture was heated to 45° C. for 12 hours. After stirring, the vessel was opened and the labeled naphthalene was isolated by filtration over Celite to remove iron rust residue and subsequently evaluated by means of ¹H, ²H and ¹³C NMR spectroscopy.

### Example 3—Catalytic Deuteration of Claritin® Using Iron Catalyst

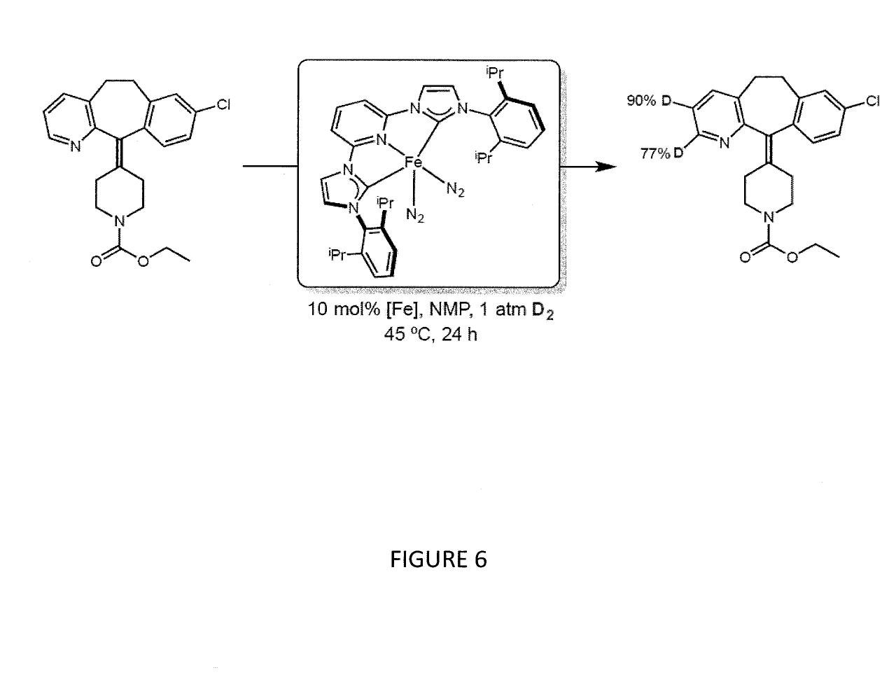

To a thick walled vessel was charged with iron catalyst [(H₄—^{iPr}CNC)Fe(N₂)₂, 0.010 g, 0.015 mmol), Claritin® (0.059 g, 0.154 mmol) and N-methyl-2-pyrrolidone (5 mmol). Deuterium gas (1 atm) was administered into the vessel at 23° C. The process was carried out under air and moisture free conditions. The resultant reaction mixture was heated to 45° C. for 24 hours. After stirring, the vessel was opened and the reaction mixture washed with water, extracted with dichloromethane, then purified over silica chromatography using DCM/MeOH as eluent. After removal of volatiles the extent of deuteration of the product mixture was analyzed using ¹H, ²H and ¹³C NMR spectroscopy. FIG. 6 illustrates the reaction scheme of the present example including the iron catalyst and resulting deuterated product.

### Example 4—Catalytic Deuteration of (−)-Nicotine Using Iron Catalyst

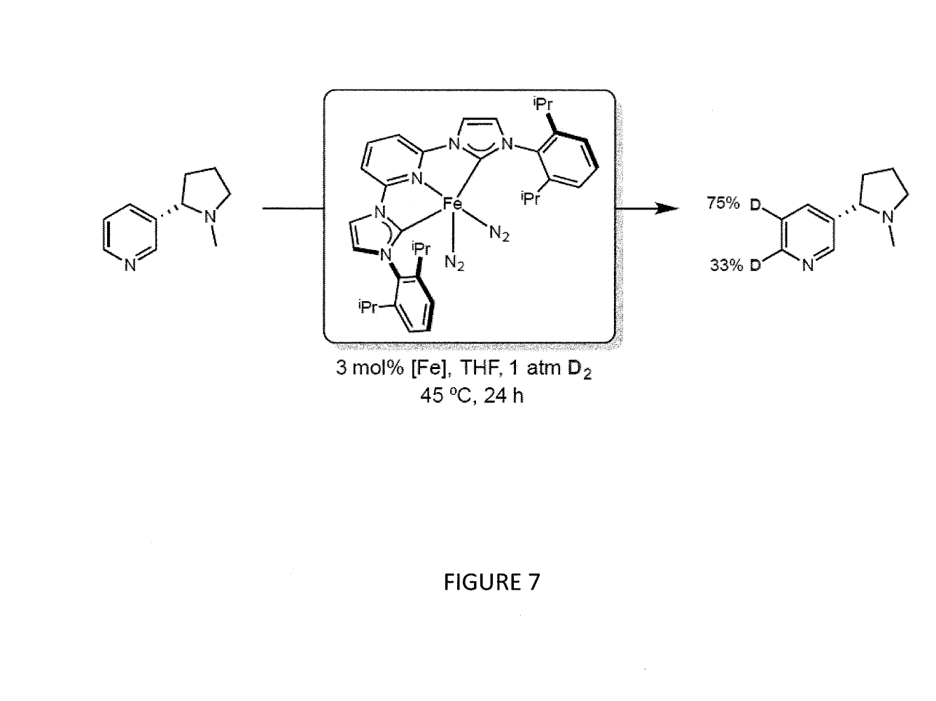

To a thick walled vessel was charged with iron catalyst [(H₄—^{iPr}CNC)Fe(N₂)₂, 0.020 g, 0.03 mmol], (−)-nicotine (0.166 g, 1 mmol) and tetrahydrofuran (9 mmol). Deuterium gas (1 atm) was administered into the vessel at 23° C. The process was carried out under air and moisture free conditions. The resultant reaction mixture was heated to 45° C. for 24 hours. After stirring, the vessel was opened and the reaction mixture was passed through a thin plug of silica. After removal of volatiles the extent of deuteration of the product mixture was analyzed using ¹H, ²H and ¹³C NMR spectroscopy. FIG. 7 illustrates the reaction scheme of the present example including the iron catalyst and resulting deuterated product.

### Example 5—Catalytic Deuteration of Papaverine Using Iron Catalyst

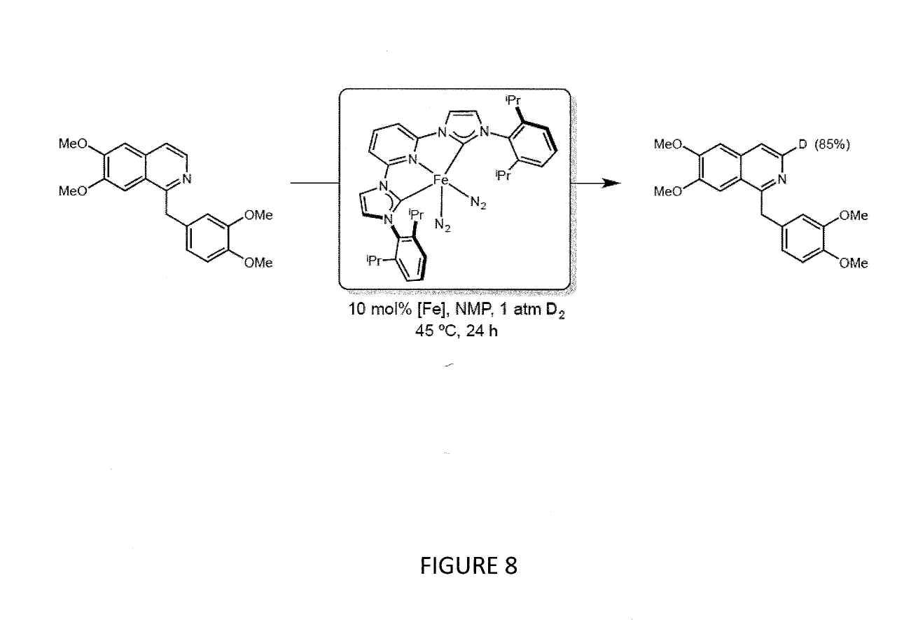

To a thick walled vessel was charged with iron catalyst [(H₄—^{iPr}CNC)Fe(N₂)₂, 0.020 g, 0.03 mmol)], papaverine (0.308 g, 0.308 mmol) and N-methyl-2-pyrrolidone (9 mmol). Deuterium gas (1 atm) was administered into the vessel at 23° C. The process was carried out under air and moisture free conditions. The resultant reaction mixture was heated to 45° C. for 24 hours. After stirring, the vessel was opened and the reaction mixture was washed with water, extracted with the ethylacetate/diethyl ether mixture and then passed through a thin plug of silica. After removal of volatiles the extent of deuteration of the product mixture was analyzed using ¹H, ²H and ¹³C NMR spectroscopy. FIG. 8 illustrates the reaction scheme of the present example including the iron catalyst and resulting deuterated product.

### Example 6—Preparation of Iron Complexes

### 1. Synthesis of (^{Mes}CNC)Fe(N₂)₂

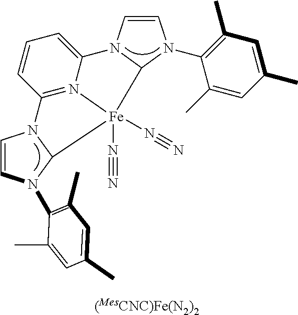

A 100 mL round-bottom flask was charged with 0.460 g of (^{Mes}CNC)FeBr₂ (0.694 mmol), 0.030 g sodium metal (1.32 mmol, 1.9 equiv) and 0.005 g naphthalene (0.039 mmol, 0.05 equiv). Approximately 20 mL of THF were added to the flask and the resulting reaction mixture was stirred under an N₂ atmosphere for 12 hours. During this time, a color change from orange to dark brown was observed. The THF was removed in vacuo and the residue was washed with diethyl ether (ca. 50 mL) then filtered through Celite, the filtrate was collected and dried in vacuo to yield 0.256 g (66%) of a dark brown solid identified as (^{Mes}CNC)Fe(N₂)₂. Analysis: Calculated (C₅₄H₅₀Fe₂N₁₆): C, 62.68; H, 4.87; N, 21.66. Found: C, 62.89; H, 4.97; N, 21.39. IR (toluene): v(N₂)=2100, 2030 cm⁻¹. ¹H NMR (benzene-d₆): δ 7.38 (d, ³J_{HH}=1.23 Hz, 2H, 4-imidazolidene H), 7.32 (4-py H), 7.05 (4-Ar H), 7.01 (3-py H), 6.98 (3-Ar H), 6.33 (d, ³J_{HH}=1.01 Hz, 2H, 5-imidazolidene H), 2.19 (s, 12H, 2,6-Ar—(CH₃)₂). ¹³C NMR (benzene-d₆): δ 230.78 (2-imidazolidene C), 141.83 (2-pyridyl C), 139.66 (1-Ar C), 137.21 (2-Ar C), 129.33 (3-AR C), 125.70 (4-Ar C), 123.54 (5 imidazolidene C), 112.63 (4-pyridyl C), 112.21 (4-imidazolidene C), 99.91 (3-pyridyl C), 18.02 (2,6-Ar—(CH₃)₂).

### 2. Synthesis of (H₄—^{iPr}CNC)Fe(N₂)₂

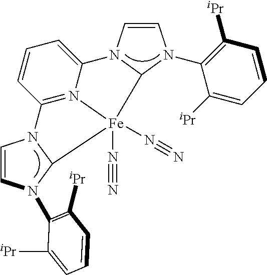

A 100 mL round-bottom flask was charged with approximately 20 mL THF, elemental mercury (9.000 g) and Na (0.045 g, 1.938 mmol). (H₄—^{iPr}CNC)FeBr₂ (0.365 g, 0.484 mmol) was added to the flask and the resulting mixture was stirred under an N₂ atmosphere for 3 hours.

During this time, a dark purple solution was observed. The solvent was then removed in vacuo. The resulting residue was extracted with 20 mL toluene, filtered through Celite, concentrated in vacuo. Layering with pentane and storing at −35° C. give 277 mg (88% yield) of a dark purple microcrystalline solid identified as (H₄—^{iPr}CNC)Fe(N₂)₂. Single crystals of (H₄—^{iPr}CNC)Fe(N₂)₂ suitable for X-ray diffraction were obtained by layering a concentrated toluene solution with pentane and storing at −15° C. Analysis for C₃₅H₄₅FeN₉: Calculated C, 64.91; H, 7.00; N, 19.46. Found: C, 64.92; H, 6.93; N, 18.97. ¹H NMR (benzene-d₆): δ 1.21 (d, ³J_{HH}=6.9 Hz, 12H, CH(CH₃)₂), 1.38 (d, ³J_{HH}=6.9 Hz, 12H, CH(CH₃)₂), 3.54 (septet, ³J_{HH}=6.8 Hz, 4H, CH(CH₃)₂), 3.61-3.75 (m, 8H, imidazolylidene backbone), 6.18 (d, ³J_{HH}=7.7 Hz, 2H, 3-pyr H), 7.10-7.21 (m, 6H, aryl H), 7.32 (t, ³J_{HH}=7.7 Hz, 1H, 4-pyr H). ¹³C {¹H}NMR (benzene-d₆): δ 24.46 (CH(CH₃)₂), 25.80 (CH(CH₃)₂), 28.49 (CH(CH₃)₂), 43.60 (imidazolylidene backbone), 56.46 (imidazolylidene backbone), 95.15 (3-pyr), 122.07 (4-pyr), 124.31 (aryl), 128.87 (aryl), 138.10 (aryl), 146.77 (2-pyr), 148.43 (aryl), 222.44 (carbene).

### 3. Synthesis of (H₄—^{iPr}CNC)Fe(H)₂(H₂)

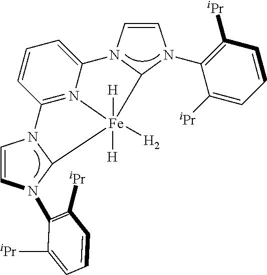

To a thick walled vessel was charged with 30 mg of (H₄—^{iPr}CNC)Fe(N₂)₂ (0.046 mmol) dissolved in 1 mL toluene. Hydrogen gas (H₂, 4 atm) was administered into the vessel at −196° C. The resultant mixture was stirred at room temperature for 2 hours, during which an orange solution was formed. The mixture was then frozen at −196° C. and the headspace of the vessel evacuated. Pentane (10 mL) was added into the vessel via vacuum transfer. The headspace was then refilled with 1 atm H₂ and the resultant mixture slowly warmed to room temperature. Orange crystals suitable for X-ray diffraction identified as (H₄—^{iPr}CNC)Fe(H)₂(H₂) formed over the period of 48 hours, which was subsequently isolated under argon atmosphere. ¹H NMR (benzene-d₆): δ 7.03 (t, ³J_{HH}=7.89 Hz, 1H, 4-py H), 6.96-6.93 (m, 6H, Ar—H), 6.05 (d, ³J_{HH}=7.89 Hz, 2H, 3-py H), 3.82-3.29 (m, 12H, imidazolidene H and Ar—CH(CH₃)₂), 1.52 (d, ³J_{HH} 6.8 Hz, 12H, Ar—CH(CH₃)₂), 1.13 (d, ³J_{HH}=6.8 Hz, 12H, Ar—CH(CH₃)₂), −11.22 (s, 4H, Fe—H). ¹³C NMR (benzene-d₆): δ 245.21 (2-imidazolidene C), 153.86 (2-pyridyl C), 148.29 (Ar C), 137.29 (Ar C), 129.07 (4-py C), 128.38 (Ar C), 124.48 (Ar C), 93.64 (3-pyridyl C), 56.65 (imidazolidene C), 42.61 (imidazolidene C) 28.39 (Ar—CH(CH₃)₂), 28.29 (2,6-Ar—(CH₃)₂), 24.18 (2,6-Ar—(CH₃)₂).

### Example 7—Preparation and Spectroscopic Characterization of (^{iPr}CNC)CoH

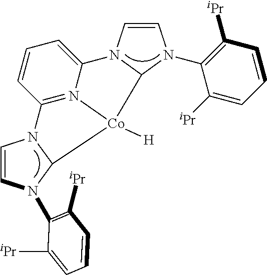

To a thick walled vessel was charged with a solution of [(^{iPr}CNC)Co(CH₃) (0.010 g, 0.017 mmol)] in benzene-d₆ (0.650 g). On the high vacuum line, the headspace was evacuated and 1 atmosphere of H₂ was admitted at −196° C. Upon thawing, the solution was shaken, but no significant color change was observed. ¹H NMR (benzene-d₆, 22° C., vacuum): 6=27.3 (br, 1H, Co—H), 0.59 (d, 7 Hz, 12H, CH(CH₃)₂), 1.25 (d, 7 Hz, 12H, CH(CH₃)₂), 3.76 (spt, 7 Hz, 4H, CH(CH₃)₂), 5.80 (d, 7 Hz, 2H, 3-py H), 7.04 (s, 6H, Ar H), 7.31 (s, 2H, imidazolylidene H), 8.22 (s, 2H, imidazolylidene H), 11.72 (t, 7 Hz, 1H, 4-py H). ¹³C NMR (benzene-d₆, 22° C., vacuum): 23.6 (CH(CH₃)₂), 23.7 (CH(CH₃)₂), 28.2 (CH(CH₃)₂), 106.8 (4-pyr, 109.2 (3-pyr), 112.8 (imidazolylidene backbone), 123.4 (aryl), 123.9 (aryl), 126.8 (imidazolylidene backbone), 140.8 (aryl), 145.0 (aryl), 145.2 (o-pyr), 187.6 (carbene).

### Example 8—Tritium Labeling of Pharmaceutical Compounds

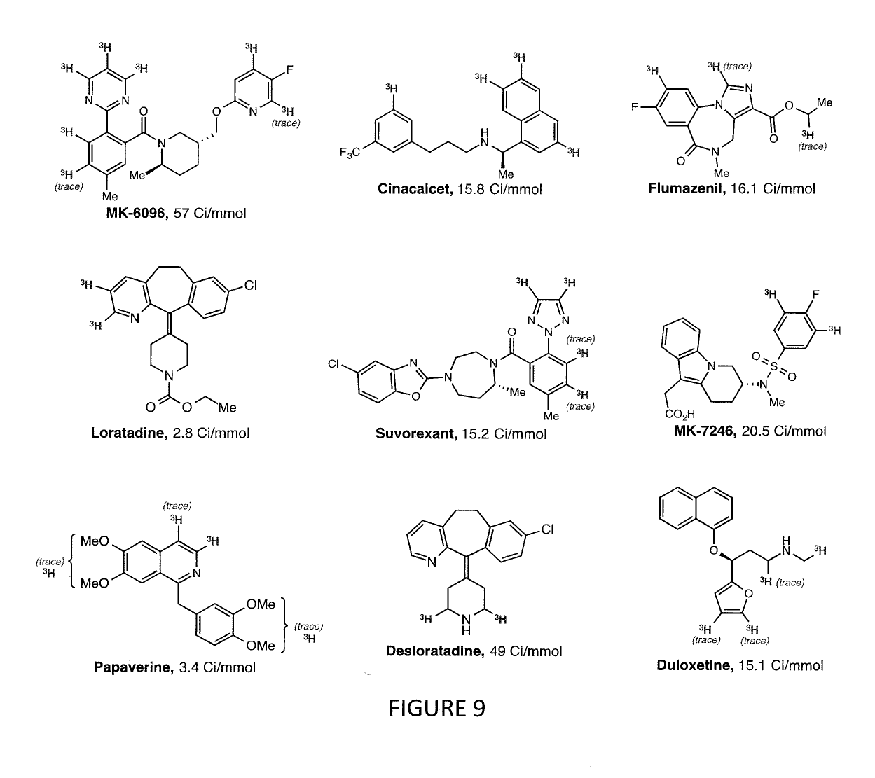

To a 1 mL glass ampule equipped with a magnetic stir bar was charged with H₄—^{iPr}CNCFe(N₂)₂ (1.2 mg), the desired drug molecule (2-3 mg) and 0.2 mL NMP. Tritium gas (1.2 Ci, 120 mmHg) was administered into the reaction vessel and the reaction mixture was stirred at 23° C. for 16 hours. After the reaction, the labile tritium was removed by successive evaporation from ethanol and the crude product analyzed by radio-HPLC. The crude product was subsequently purified by semi-preparative reverse phase HPLC. The values given under each compound are the radiochemical yields. FIG. 9 illustrates various drug molecules labeled with tritium according to the present example.

1. An iron complex of formula (I): 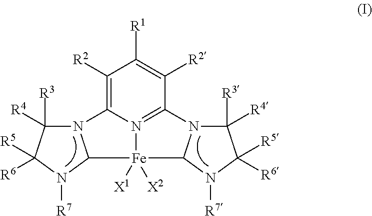
wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹ and X² are independently selected from the group consisting of hydrogen, alkyl, aryl, heteroalkyl, heteroaryl, H₂, N₂ and halo.

2. The iron complex of claim 1, wherein R⁷ and R^{7′} are aryl-alkyl.

3. The iron complex of claim 2, wherein R⁷ and R^{7′} are 2,6-diisopropyl-phenyl.

4. The iron complex of claim 2, wherein X¹ and X² are independently selected from the group consisting of hydrogen, H₂ and N₂.

5. An iron complex of formula (II): 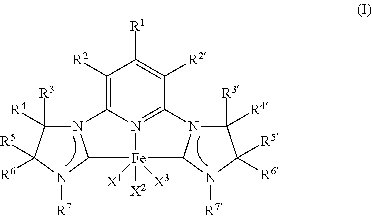
wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹-X³ are independently selected from the group consisting of hydrogen, alkyl, aryl, heteroalkyl, heteroaryl, H₂, N₂ and halo.

6. The iron complex of claim 5, wherein R⁷ and R^{7′} are aryl-alkyl.

7. The iron complex of claim 6, wherein R⁷ and R^{7′} are 2,6-diisopropyl-phenyl.

8. The iron complex of claim 6, wherein X¹ and X² are independently selected from the group consisting of hydrogen, H₂ and N₂.

9. A method of isotopically labeling an organic compound comprising:
providing a reaction mixture including the organic compound, an iron complex and a source of deuterium or tritium; and
labeling the organic compound with deuterium or tritium in the presence of the iron complex or derivative thereof, wherein the iron complex is of formula (I): 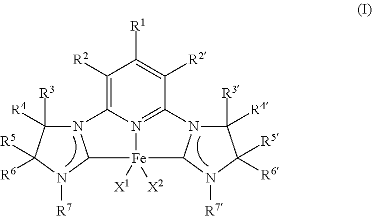
wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹ and X² are independently selected from the group consisting of hydrogen, alkyl, aryl, heteroalkyl, heteroaryl, N₂ and halo.

10-12. (canceled)

13. The method of claim 9, wherein an aryl or heteroaryl moiety of the organic compound is labeled with deuterium or tritium.

14. The method of claim 9, wherein an aliphatic carbon alpha to an NH functionality of the organic compound is labeled with the deuterium or tritium.

15. The method of claim 9, wherein the organic compound is a pharmaceutical composition.

16. (canceled)

17. The method of claim 9, wherein X¹ and X² are N₂ and R⁷ and R^{7′} are aryl-alkyl.

18. The method of claim 9, wherein R⁷ and R^{7′} are 2,6-diisopropyl-phenyl.

19. A method of isotopically labeling an organic compound comprising:
providing a reaction mixture including the organic compound, an iron complex and a source of deuterium or tritium; and
labeling the organic compound with deuterium or tritium in the presence of the iron complex or derivative thereof, wherein the iron complex is of formula (II): 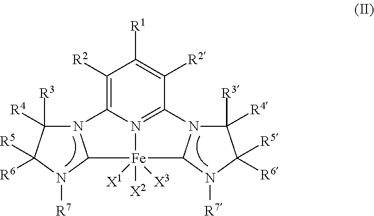
wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹-X³ are independently selected from the group consisting of hydrogen, alkyl, aryl, heteroalkyl, heteroaryl, N₂ and halo.

20. The method of claim 19, wherein X¹ is N₂ and X² and X³ are independently selected from the group consisting of hydrogen, H₂, alkyl, aryl, heteroalkyl and heteroaryl.

21. The method of claim 20, wherein the heteroalkyl is of formula 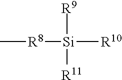
wherein R⁸ is selected from the group consisting of alkyl, alkenyl, aryl, heteroaryl, alkyl-aryl, alkyl-heteroaryl, aryl-alkyl and heteroaryl-alkyl and R⁹-R¹¹ are independently selected from the group consisting of hydrogen, alkyl, alkenyl, aryl, alkyl-aryl, alkoxy and hydroxy.

22. The method of claim 20, wherein R⁷ and R^{7′} are aryl-alkyl.

23. The method of claim 22, wherein R⁷ and R^{7′} are 2,6-diisopropyl-phenyl.

24. A method of isotopically labeling an organic compound comprising:
providing a reaction mixture including the organic compound, an iron complex and a source of deuterium or tritium; and
labeling the organic compound with deuterium or tritium in the presence of the iron complex or derivative thereof, wherein the iron complex is of formula (V): 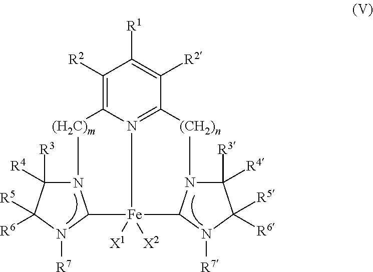
wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹ and X² are independently selected from the group consisting of hydrogen, alkyl, aryl, heteroalkyl, heteroaryl, H₂, N₂ and halo and wherein m and n are integers independently selected from 1 to 5.

25. The method of claim 24, wherein R⁷ and R^{7′} are aryl-alkyl.

26. The method of claim 25, wherein R⁷ and R^{7′} are 2,6-diisopropyl-phenyl.

27-29. (canceled)

30. The method of claim 9, wherein the deuterium source is D₂ gas.

31. The method of claim 30, wherein the D₂ gas is provided to reaction mixture at a pressure of 0.35 to 4 atm.

32. The method of claim 30, wherein the D₂ gas is provided to reaction mixture at sub-atmospheric pressure.

33. The method of claim 9, wherein the deuterium source is a deuterated organic compound.

34. The method of claim 9, wherein the tritium source is T₂ gas.

35. The method of claim 34, wherein the T₂ gas is provided to reaction mixture at sub-atmospheric pressure.

36. The method of claim 9, wherein the tritium source is THO.

37. The method of claim 9, wherein the organic compound is solvent of the reaction mixture.

38. The method of claim 9, wherein reaction mixture comprises an aprotic solvent.

39. A method of conducting an isotopic labeling study comprising:
providing a reaction mixture comprising a pharmaceutical compound, an iron complex or a cobalt complex and a source of tritium;
labeling the pharmaceutical complex with tritium in the presence of the iron complex, cobalt complex or derivatives thereof;
recovering the tritium labeled pharmaceutical compound from the reaction mixture; and
administering the tritium labeled pharmaceutical compound in vitro or in vivo.

40. The method of claim 39, wherein the iron complex or cobalt complex comprises N-heterocylic carbene ligands.

41. (canceled)

42. (canceled)

43. The method of claim 39, wherein an aryl or heteroaryl moiety of the pharmaceutical compound is tritium labeled.

44. The method of claim 39, wherein an aliphatic carbon alpha to an NH functionality of the pharmaceutical compound is tritium labeled.

45. The method of claim 39, wherein the iron complex is present in the reaction mixture and is of formula: 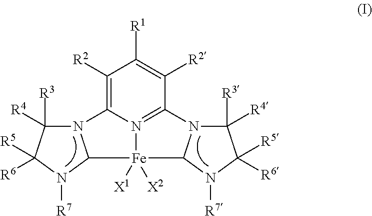
wherein R¹-R⁷ and R^{2′}-R^{7′} are independently selected from the group consisting of hydrogen, alkyl, heteroalkyl, cycloalkyl, heterocycloalkyl, aryl, heteroaryl, alkyl-aryl, alkyl-heteroaryl, aryl-alkyl and heteroaryl-alkyl, wherein the alkyl, heteroalkyl, cycloalkyl, heterocycloalkyl, aryl, heteroaryl, alkyl-aryl, alkyl-heteroaryl, aryl-alkyl and heteroaryl-alkyl are optionally substituted with one or more substituents selected from the group consisting of (C₁-C₁₀)-alkyl and (C₁-C₁₀)-alkenyl and wherein X¹ and X² are independently selected from the group consisting of hydrogen, alkyl, aryl, heteroalkyl, heteroaryl, H₂, N₂ and halo.

46. A method of isotopically labeling an organic compound comprising:
providing a reaction mixture including the organic compound, an iron complex or a cobalt complex and a source of deuterium comprising a deuterated organic compound; and
labeling the organic compound with deuterium or tritium in the presence of the iron complex or cobalt complex or derivatives thereof.

47. The method of claim 46, wherein the organic compound is a pharmaceutical composition.
